(19) United States
(12) Patent Application Publication
(10) Pub. No.: US 2012/0088507 A1
(43) Pub. Date: Apr. 12, 2012

(54) METHOD FOR HANDOVER PROBLEM IDENTIFICATION

(75) Inventors: Peter Legg, Kista (SE); Johan Johansson, Kungsangen (SE); Henrik Olofsson, Kista (SE)

(73) Assignee: Huawei Technologies Co., Ltd., Shenzhen (CN)

(21) Appl. No.: 13/278,756

(22) Filed: Oct. 21, 2011

Related U.S. Application Data
(63) Continuation of application No. PCT/CN2009/071391, filed on Apr. 21, 2009.

(51) Int. Cl. H04W 36/30; H04W 24/00

(52) U.S. Cl. 455/436

(57) ABSTRACT

Method for handover problem identification in a mobile telecommunications system, the system including at least a first radio basestation, a second radio basestation and a mobile terminal able to communicate with said basestations, said mobile terminal is adapted to do a handover from the first basestation to the second basestation, the method including the steps of:
take at least one measure of a link quality between the terminal and any of the stations,
evaluate any measure of a link quality in regard of handover problem identification,
   The invention is distinguished by:
in the step of taking the at least one measure, take said at least one measure of a link quality at an end of a successful handover execution of the mobile terminal from the first basestation to the second basestation. The invention also comprises a mobile terminal, a radio basestation and a management entity.

### CROSS-REFERENCE TO RELATED APPLICATIONS

This application is a continuation of International Application No. PCT/CN2009/071391, filed on Apr. 21, 2009, which is hereby incorporated by reference in its entirety.

### FIELD OF THE INVENTION

The present invention concerns a method for handover problem identification in a mobile telecommunications system. Further, it concerns a mobile terminal for a mobile telecommunications system, a radio basestation for a mobile telecommunications system and a management entity for a mobile telecommunications system.

### BACKGROUND ART

The context of the background art (and the invention) is a cellular wireless network system. Such a system may include at least a first radio basestation and a second radio basestation which are able to communicate with a mobile terminal. Further, the mobile terminal is adapted to do a handover from the first basestation to the second basestation, meaning that the mobile terminal can switch communication from the first basestation to the second basestation as it travels the network.

Depending on what type of cellular network system one is referring to, the entities in such a system are named differently. For instance, in a 3GPP Long Term Evolution (LTE) system, the mobile terminal is named User Equipment, in short UE. Also, a radio basestation in LTE is termed “E-UTRAN Node B” or eNB for short. Other systems have other naming conventions. In this application, unless indicated otherwise, the use of a term is intended to encompass the general meaning of that term applicable to any mobile cellular network system. For instance, a UE is meant to denote any mobile terminal as applicable, irrespective of type of cellular wireless network system it is operating in, be it GSM, UMTS, LTE, etc.

Normally a mobile terminal in active mode in a cellular wireless network is handed over from one cell to the next as it moves through the network, and data can be transmitted and received without significant interruptions due to these handovers.

The handover (HO) procedure can consist of many steps. In most cellular wireless systems the handover is 1) network controlled, i.e. the mobile terminal is commanded by the network when to connect to another cell, 2) prepared, i.e. the target cell (the cell that mobile terminal is moving to) is prepared, 3) mobile terminal assisted, i.e. the mobile terminal provides measurement reports before handover, to the serving cell to assist the decision to do handover preparation of target cell(s), and when to leave the serving cell/connect to the target cell. In the context of handover, the serving cell before HO is often referred to as the source cell. After successful HO the target cell becomes the new serving cell. In LTE the handover is a “hard handover”: the mobile terminal radio link is switched from one cell (source) to another (target). In Universal Mobile Telecommunications System, UMTS, hard handovers are used exclusively in Time-division duplex (TDD) mode and may also be used for Frequency-division duplex (FDD) mode too.

In the following discussion, see FIG. 1, we focus on the intra frequency LTE HO procedure, but the procedures are similar for the LTE Inter Radio Access Technology (RAT) and LTE inter frequency HO procedures. The intra E-UTRAN in RRC_CONNECTED state is a mobile terminal, in LTE terminology “UE”, assisted network controlled handover, with handover preparation signalling in E-UTRAN. FIG. 1 depicts the basic handover scenario where core network nodes associated to the mobile terminal (the Mobility Management Entity (MME) and Serving Gateway (S-GW)) do not change.

The handover is initially triggered by a measurement report sent from the UE to the serving eNB (radio basestation). The serving eNB configures how the UE shall take measurements (“Measurement Control” step 1 in FIG. 1) and under what conditions a measurement report shall be triggered and sent to the eNB.

To assist mobility control decisions, the UE can measure several cells and report the results to the network. Different networks and network deployments can have different detailed behaviour, but in most networks it is natural to trigger handover when signal reception from target cell is better than from source cell (FIG. 2). For the case of intra-frequency HO in a reuse-one system (source cell and target cell use exactly the same frequency resources), there are strong interference management benefits in keeping the UE always connected to the best cell. In the measurement report the UE includes the reason for the trigger (e.g. target cell stronger than serving cell) and measurements of the reference signal strength (RSRP) or quality (RSRQ) of the serving cell and several neighbours (including as a minimum the target cell). To reduce ping-pong effects where a UE hands over repeatedly between two cells a handover offset is often added to the trigger condition: target cell should be better than the serving cell by the offset (offset>0 dB).

When the serving eNB receives a measurement report if it desires to handover the UE to another cell it performs a handover preparation to that cell. Handover preparation involves a signalling exchange between one eNB and another. The source cell requests the handover (Handover Request, FIG. 1, step 4) and passes over UE context information; the target cell decides if it can admit the UE (Call Admission Control, FIG. 1, step 5) and either accepts or rejects the handover. In the acceptance message (Handover Request Ack. FIG. 1, Step 6) the target cell includes parameters required by the UE to allow it to communicate to the target cell—these parameters are grouped into a transparent container. The source cell can prepare multiple cells for handover but this is not relevant to the discussion here.

Following a successful preparation, the handover execution takes place. The source cell issues the HO Command to the UE (FIG. 1, step 7)—this is the RRCConnectionReconfiguration message and carries the transparent container. If and when the UE receives this correctly it synchronises to the new target cell and sends a synchronisation message on the Random Access Channel, RACH, (FIG. 1, step 9). The target cell then issues an allocation to the UE (FIG. 1, step 10) so that it can send a HO Confirmation message to the target cell (the RRCConnectionReconfigurationComplete message, step 11).

The final steps, the Handover Completion, do not involve the UE. The source eNB is able to forward data (unacknowledged downlink packets) to the target eNB, and the S1-U interface from the S-GW must be switched from the source to the target (“path switch”). Finally, if the handover is successful the target eNB issues a UE Context Release message to the source eNB.

The UMTS hard handover is very similar in many respects—it is also UE assisted but network controlled (the UE is configured to send triggered measurement reports but the network decides when to execute a handover), exploits preparation (using Radio Link Setup procedure), is a “backward” handover (the source cell sends the HO command to the UE and the UE replies to the target cell) and is completed by inter-node signalling.

### Self-Organising Networks: Handover Optimisation

In 3GPP there has been considerable study into Self-Organising Networks (SON) for LTE. One subset of self-organisation is self-optimisation. In self-optimisation the performance of a radio network (a set of eNBs) may be improved without manual intervention by the operator using SON functionality located either in the eNBs themselves or in the Operations & Maintenance (OAM) system (or both). One aspect which has been studied is the use-case of Handover Parameter Optimisation aka Mobility Robustness Optimisation (MRO). There are two main aspects of handovers which have been identified as within the remit of MRO:

Reducing handover failures

Reducing unnecessary handovers.

### Cases of Handover Failures

Handovers fail when either:

a) the HO is too late (the HO command from the source cell to the UE is not received successfully by the UE), or
b) the HO is too early (the HO command is received OK but the transmission of the HO Response (or associated signalling, steps 9 and 10 in FIG. 1) by the UE to the target eNB fails).

Unnecessary handovers occur when a handover occurs too early but is successful. Often a UE can repeatedly handover between two cells (“ping-pong”).

An example scenario for too late HO triggering is shown in FIG. 3. Due to fast movement and inadequate HO parameter setting, the UE leaves the source cell coverage before the HO is triggered. If the UE mobility is more aggressive than what the HO parameter settings allow for, the HO could be triggered when the signal strength of the serving cell is already too low or may not be triggered at all if a radio link failure pre-empts it. The connection may be re-established on a different cell from the serving cell. This is a common scenario in areas where user mobility is very high, such as along the highways, train lines etc.

An example scenario for too early HO triggering is shown in FIG. 4. HO can be triggered when the UE enters an unintended island of coverage of the target cell inside the intended coverage area of the serving cell. When the UE exits the island of coverage of the target cell, it cannot acquire the target cell anymore and the HO fails, potentially leading to a radio link failure. This is a typical scenario for areas where fragmented cell coverage is inherent to the radio propagation environment, such as dense urban areas.

HO procedure is resource-consuming and therefore costly to the network operator. Sometimes, the combination of user mobility patterns and cell coverage boundary layout can generate frequent unnecessary HOs that consume network resources inefficiently. This scenario is illustrated in FIG. 5. A handover parameter optimisation function should aim at detecting such scenarios. These scenarios sometimes can be remedied by HO parameter optimisation, as illustrated in FIG. 6. Since the goal of reducing unnecessary HOs can sometimes be opposed to the goal of reducing the number of HO failures, operators should be able to set the tradeoff point.

### Handover Performance Studies:

### Handover Counting

In 3GPP methods to count handover failures have been discussed and standardized in order to monitor such failures. These are Performance Measurements (PM) that are taken by the eNB and then passed up to the OAM system. The measurements are taken at the source eNB and count:

a) handover attempts (identified by the eNB sending the HO command to the UE)
b) handover successes (identified by the reception of the UE Context Release)
c) handover failures (from measurements (a) and (b) by subtraction).

These measurements simply capture handover failure statistics but give no indication of the reason for failure.

Handover Failure with Early or Late Identification

There have been proposals to capture Performance Measurements, PM, for the number of handover failures that result from too early handover or too late handover. Too early handovers are recognized by a re-attachment of the UE to the source cell following the failure, and too late handovers by a re-attachment to the target cell. PM are passed to the OAM system where the SON entity is located.

However, a main drawback with this approach is that confidence in the handover settings can only be gained by capturing the results of a large number of handovers. If, taking an example, 1000 handovers are measured and 20 fail (too early HO failures, zero too late failures) then this indicates a 2% failure rate. If the target failure rate is 1% then the SON entity will make an adjustment to a handover parameter but it will require 1000 more handovers to be logged before it is apparent if the adjustment has reduced the failure rate and whether the target is now met. Furthermore, it is difficult to extrapolate the measurements to handle future changes to the environment that may impact handover performance—examples are UE speed, locations of handover between the two cells, UE Discontinuous Reception, DRX, settings. In conclusion, this is quite a crude measurement and only provides limited information to the SON entity.

### UE Measurements at Point of Handover Trigger

Another proposal to identify handover problems is the proposition that the early or lateness of a handover could be determined by considering the Reference Signal Received Quality, RSRQ, measurements of the serving and target cell that are passed from the UE to the eNB in the triggered measurement report, as indicated in FIG. 7.

Then, the characteristics of a too late measurement report triggering are:

High difference between the quality of the neighbour cell and the serving cell (Dn-s)

Low quality of the serving cell (Qs)

High quality of the neighbour cell (Qn)

As indicated in FIG. 7.

The characteristics of a too early measurement report triggering are:

Small Dn-s

Not low Qs

Not high Qn

As indicated in FIG. 8.

It has been proposed that statistics on these parameters could be collected and signaled as Performance Measurements, PM, to the OAM system.

### Rapid Handover Identification Using UE History

UE History represents, in an LTE system, a record of the handover history of a UE, basically an accumulating record of when the UE handed over between two cells. It is passed from one eNB to another during handover (in the HO Preparation part). It can be used to determine when a rapid handover has occurred A->C->B when maybe A->B would have been possible by delaying the first handover, compare FIG. 9. This is also called the needle case. Ping-pong A->B->A can also be recognized using UE history, compare FIG. 5.

As explained in FIG. 9, a rapid handover is identified when the UE stayed in Cell A for a period of time larger than regular handover dwell time and then was handed over from source Cell A to a target Cell C. Shortly after this handover, the UE hands over to its next target Cell B. The UE stays in Cell C only in a period of time shorter than regular handover dwell time. In the above case, the stated handover can be made more simple provided that the Cell A directly hands over to Cell B if the coverage of them allows. This measurement is also used to measure too early handovers (e.g. from Cell A to target Cell C). On the basis of gathered statistics, optimization of handover parameters can be done.

Disadvantages with this approach, similar to those of the early/late counters, handover failure with early/late identification, are that the Self Organising Network, SON, entity must be reactive not pro-active.

In another approach, a reception quality estimating method estimates reception quality of a wireless communication area for estimating success or failure of handover processing occurring in a service area of a wireless communication system including a plurality of base stations. The method includes a first step and a second step. In the first step, the reception qualities of radio waves from the plurality of base stations are acquired at a given location within the service area. In the second step, the start point and end point of the handover processing are estimated by referring to time required for the handover processing, moving speed of a mobile terminal, which are previously input, and the reception qualities, and then success or failure of the handover processing is estimated by referring to the reception qualities of radio waves from the base stations at the start point and end point of the handover processing.”

In another approach, a reception quality estimating method estimates reception quality of a wireless communication area for estimating success or failure of handover processing occurring in a service area of a wireless communication system including a plurality of base stations. The method employs a test mobile to sample the received quality from different basestations (results are logged, e.g., in a database). The handover success can then be estimated by estimating where a UE would travel to following a handover trigger event at a given location in the network (given the handover execution time, speed and direction of the UE)—the radio quality to participating basestations at the start and the end of the virtual handover is taken from the database. In summary, the method does not consider measurements from real handovers, it is an off-line method that can be used before there are any active users in the network. However, the method does not address the performance of real handovers; it is based upon a number of assumptions which introduce inaccuracies.

There are other approaches that have been proposed that are similar to the ones described above. For instance, other approaches proposing to use UE History (or something similar) to determine handover success/failure rates, in effect implementing a relatively simple HO failure counter approach.

Thus, there have been numerous proposed solutions to the problem of identifying non-optimal handover behaviour in a mobile cellular network. However, still there is no catch-all solution and therefore improved methods in view of solving this problem are needed.

### SUMMARY OF THE INVENTION

It is an object of the present invention to propose a solution for or a reduction of the problems of prior art. A main object is consequently to propose an improved method for identifying and describing non-ideal hard handover behaviour, for instance in an LTE or UMTS radio network.

According to the invention this is accomplished by a method having the features of claim 1.

The proponents postulate that the method can reduce too early handover failures and reduce unnecessary handovers (ping-pong or needle effect).

In one aspect of the invention, the solution involves the capturing of at least one measure of a link quality between the mobile terminal and a radio basestation at the time of handover execution completion. Possibly several downlink and uplink measurements for the mobile terminal. Analysis of this measurement(s) indicates non-ideal handover behaviour. According to a further aspect of the invention, further indications are possible if measurements on the downlink are additionally captured at the time of the handover trigger point, and, according to yet a further aspect of the invention, additionally shortly after the handover execution.

In this way, compared to the prior art approach “UE measurements at point of handover trigger”, further information on handovers can be gathered covering further use cases. In the prior art approach mentioned, it can be observed that too late handovers are distinguished by the measurement values passed at the trigger point to the basestation. This is because too late handovers involve problems in the downlink from the source basestation to the mobile terminal (the sending of the HO Command) and if the preparation time is short we would expect the radio conditions to be similar at the point of HO Command to those reported at the trigger point.

However, too early handovers that may lead to radio link failure are distinguished by problems with transmissions to and from the target basestation and the mobile terminal, and these occur some time after the trigger event and also involve the uplink. This is emphasized in FIG. 4.

In LTE the time interval between the triggered measurement report and the end of the handover execution is approximately 100 ms. For low speed mobile terminals this corresponds to a very small distance and we would not expect a large change in radio conditions over this period unless the radio shadowing and scattering environment is particularly challenging. Therefore, the prior art approach “UE measurements at point of handover trigger” should work for identifying the propensity for radio link failures due to early handovers for mobile terminals of low speed. However, for high speed mobile terminals, such as in high speed trains, differences are expected (e.g. 100 m/s (360 km/h)100 ms corresponds to 10 m). Furthermore, in UMTS hard handovers the interval is much longer (several 100 ms) so the limitations will be apparent at lower speeds (e.g. 500 ms interval, 10 m is traveled for a 20 m/s (72 km/h) UE. Additionally, the prior art does not provide information on the radio conditions immediately after the handover.

Thus, the invention is useful in identifying handover problems including:

Too early handover (leading to handover failure)

Too early handover (leading to ping-pong)

Too early handover (leading to unnecessary handover to intermediate cell, the needle case).

Using the invention a handover parameter optimisation function may determine how to adjust handover parameters to reduce or eliminate the non-ideal behaviour.

According to one aspect of the invention, the solution captures for every successful handover between two cells any or all of the following information for the handover parameter optimisation function:

At the end of handover execution
Uplink link quality from mobile terminal to target cell
Downlink link quality from target cell to mobile terminal
Downlink link quality from source cell to mobile terminal

According to a further aspect of the invention, the solution additionally captures:

At the handover trigger
Uplink link quality from mobile terminal to target cell
Downlink link quality from target cell to mobile terminal
Downlink link quality from source cell to mobile terminal

According to a further aspect of the invention, the solution additionally captures:

Shortly after handover execution (first few seconds)
Uplink link quality from mobile terminal to target cell
Downlink link quality from target cell to mobile terminal
Downlink link quality from source cell to mobile terminal

After capturing one or more measurements, preferably a plurality of measurements from a statistically significant number of handovers, the following problems may be recognised

Too early handover (leading to handover failure)
Uplink link quality from mobile terminal to target cell or the downlink link quality from target cell to mobile terminal at the end of handover execution are poor (below specified respective thresholds), but not poor enough to cause a handover failure (since successful handover events are captured)

Too early handover (leading to ping-pong)
The difference between target cell downlink quality and source cell downlink quality is small at the end of the handover execution.
The difference between target cell downlink quality and source cell downlink quality reduces after the handover execution.

Too early handover (leading to unnecessary handover to intermediate cell, the needle case).
Both the source and target downlink link qualities deteriorate with time (between the trigger and the end of the handover execution—two sets of measurements)
Both the source and target downlink link qualities deteriorate with time after the HO execution

The invention also includes means to present relevant measurements to the source or target eNB for LTE.

### BRIEF DESCRIPTION OF THE DRAWINGS

Embodiments exemplifying the invention will now be described, by means of the appended drawings, on which

FIG. 1 illustrates a handover in a Evolved UTRAN mobile telephony system,

FIG. 2 illustrates a typical 2 cell handover scenario, mobile terminal mobility measurements,

FIG. 3 illustrates a too late handover triggering scenario,

FIG. 4 illustrates a too early HO triggering scenario,

FIG. 5 illustrates an inefficient use of network resources caused by multiple handovers, “ping-pong”,

FIG. 6 illustrates how handover parameter adjustment prevents frequent handovers as in FIG. 5,

FIG. 7 illustrates an example of too late triggering of the measurement report based on event A3,

FIG. 8 illustrates an example of too early triggering of the measurement report based on event A3,

FIG. 9 illustrates a fast handover spanning three different cells,

FIG. 10 illustrates a flow chart showing steps of an embodiment of the present invention,

FIG. 11a illustrates measurement capture in an embodiment of the invention,

FIG. 11b illustrates measurement capture in an embodiment of the invention,

FIG. 12 illustrates trend possibilities for RSRQ measurements by mobile terminal.

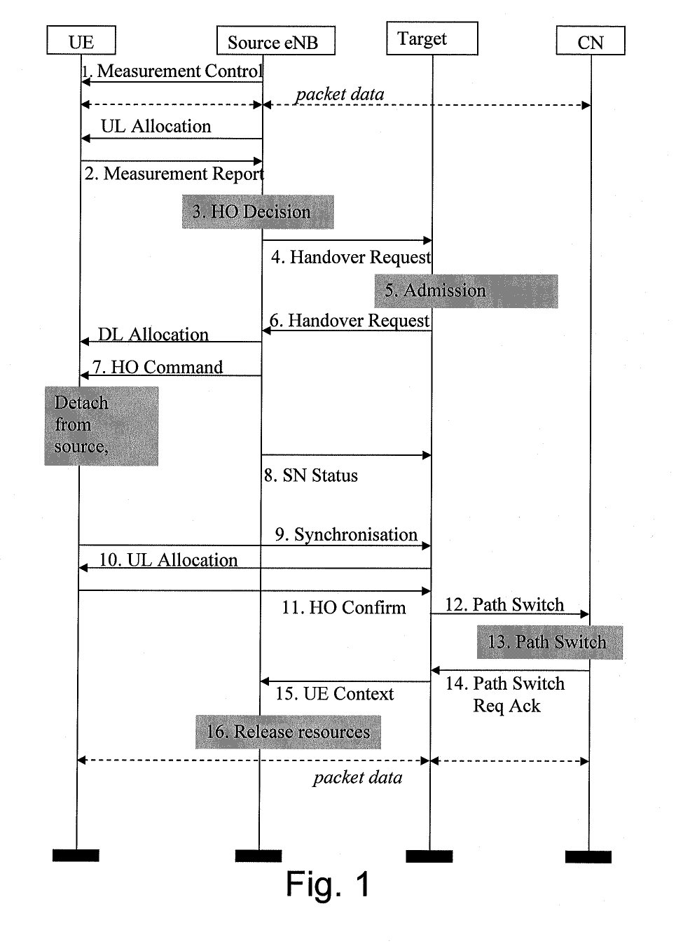

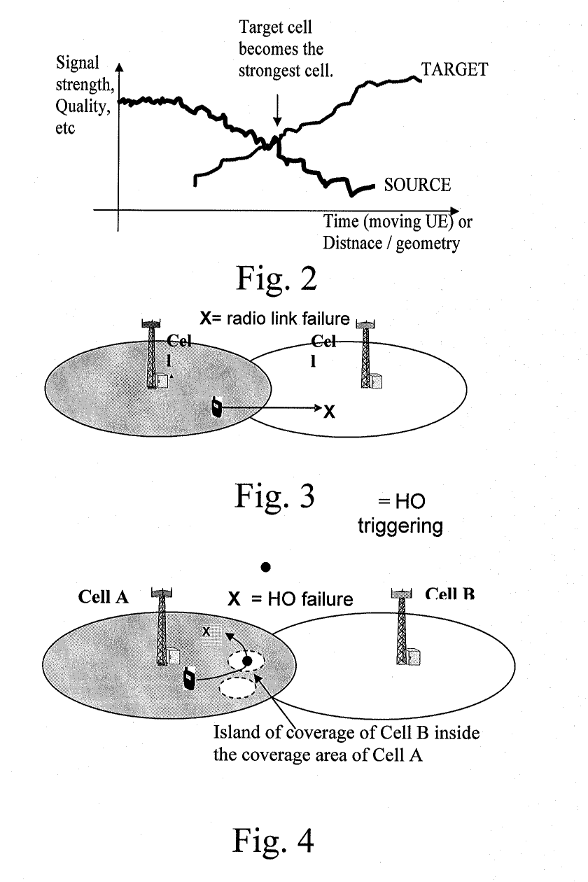

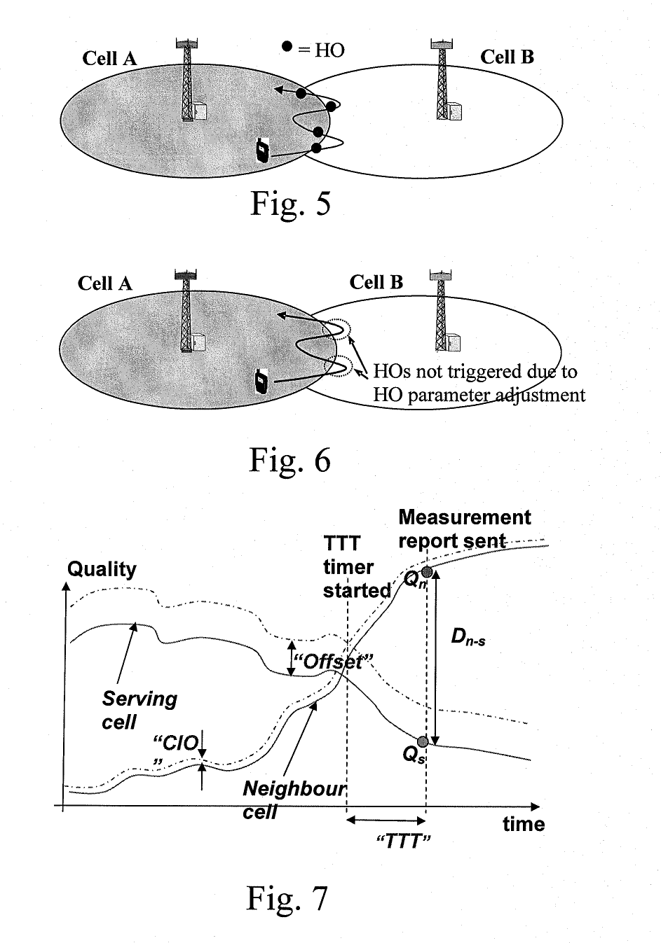

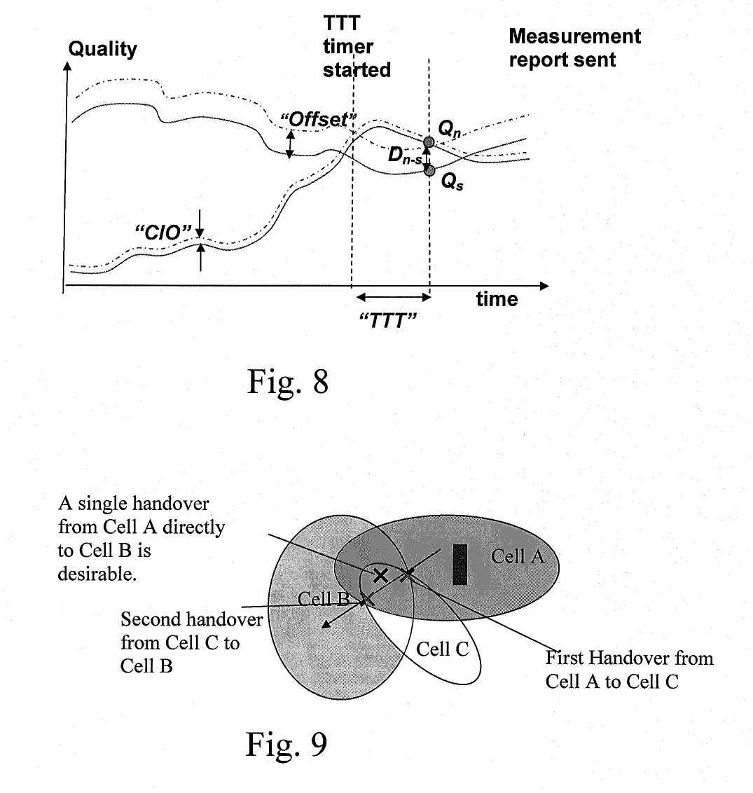

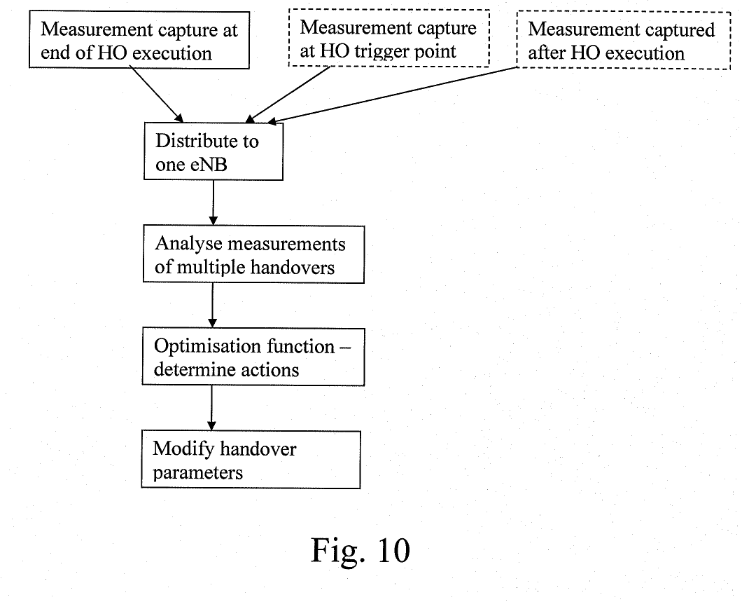

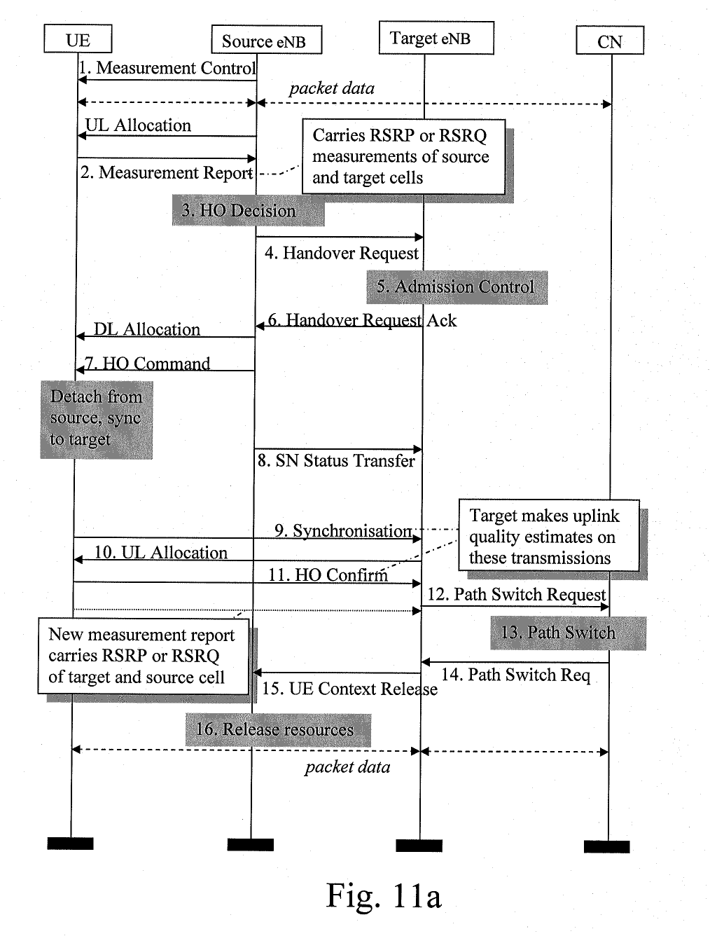

### DETAILED DESCRIPTION OF THE INVENTION

A preferred embodiment represents a means to identify and correct non-ideal handover behaviour, for instance in the E-UTRAN. The solution takes one or more measurements of the radio conditions between the mobile terminal and the target and source cells for successful handovers. Measurement(s) is (are) taken at the end of the handover execution and optionally at the trigger point and optionally at intervals following the handover. Several measurements (pertaining to a particular handover, e.g. cell A to cell B) can be gathered at one point to facilitate analysis. As a result of an optimisation procedure on the analysed results, the handover parameters governing the particular handover may be changed. The method aims to proactively adjust the handover parameters towards an optimum point. This can, for example, eliminate handovers failing in a too-early fashion. The solution to the problem thus may comprise the following steps:

1. measurement capture on successful handovers
2. measurement distribution
3. measurement analysis and identification of corrective actions (if any)
4. handover parameter adjustment to make handover more optimum

An important aspect of the invention is the capturing of measurements of downlink and uplink link quality at the end of the handover execution and optionally additionally at the beginning of the handover (trigger point). Optionally, additional measurement capture after the handover is also within the scope of the invention and is particularly useful for low-speed UEs for whom radio conditions change slowly with time.

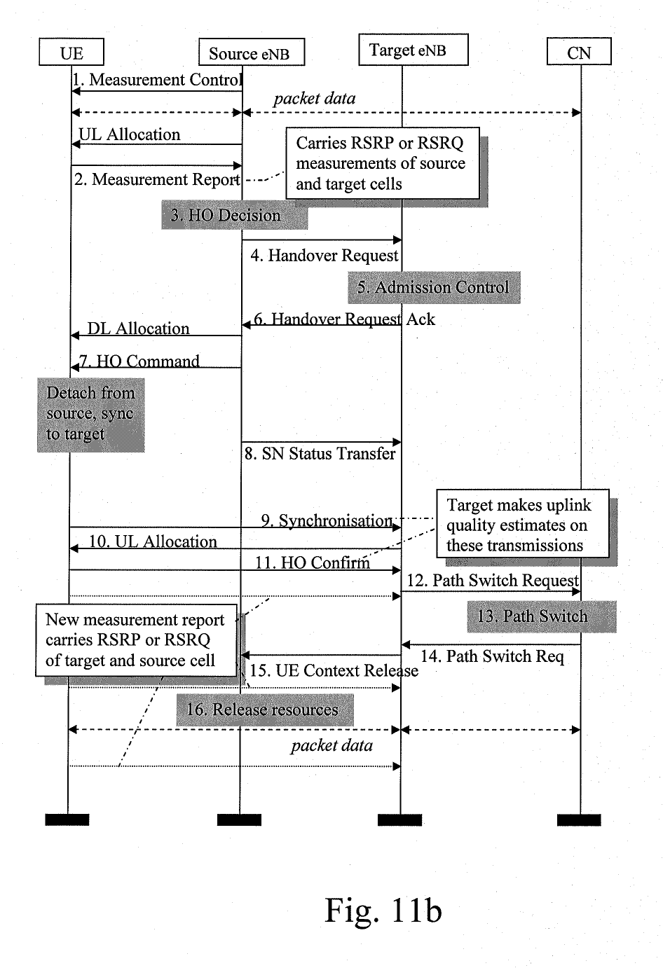

The method for handover problem identification in a mobile telecommunications system, in accordance with the invention will now be described in detail with reference to FIG. 11a. Said mobile telecommunications system includes at least a first radio basestation, a second radio basestation and a mobile terminal able to communicate with said basestations, wherein said mobile terminal is adapted to do a handover from the first basestation to the second basestation. The method for handover problem identification includes the steps of:

taking at least one measure of a link quality between the terminal and any of the stations,

evaluating any measure of a link quality in regard of handover problem identification, and

in the step of taking the at least one measure of a link quality, take said at least one measure of a link quality at an end of a successful handover execution of the mobile terminal from the first basestation to the second basestation.

Normally, the at least one measure of a link quality would in fact be several measures on subsequent successful handovers collected. However, taking only even one single measure may provide some information enough to make some sort of evaluation on that measure.

As mentioned above, the method according to the invention may further comprise a step:

additionally taking at least one second measure on link quality between the terminal and any of the basestations at a time of a handover trigger of the mobile terminal.

Further, the method according to the invention may further comprise, possibly in combination with any other optional step of the method, a step:

additionally taking at least one third measure on link quality between the terminal and any of the basestations in a time interval between a time of a handover trigger and a time of a handover execution completion of the mobile terminal.

Further, the method according to the invention may further comprise, possibly in combination with any other optional step of the method, a step:

additionally taking at least one fourth measure on link quality between the mobile terminal and any of the basestations in a time interval following handover completion of the mobile terminal.

Normally, the at least one second, third and fourth measures on a link quality would in fact be several second, third and fourth measures on subsequent successful handovers collected. However, taking only even one single second, third or fourth measure may provide some information enough to make an evaluation on that measure.

In conjunction with the step of taking a fourth measure on link quality, the method according to the invention may further comprise: in the time interval following handover completion:

taking multiple measures on link quality between the terminal and any of the basestations periodically in the time interval.

For any measure of a link quality between the terminal and any of the basestations mentioned above, the method could comprise a step:

taking as said any measure of a link quality any of: uplink link quality from mobile terminal to second basestation, uplink link quality from mobile terminal to first basestation, downlink link quality from second basestation to mobile terminal, and downlink link quality from first basestation to mobile terminal.

Downlink quality measurements must be taken by the UE and then sent to the eNB. Firstly, we describe a preferred embodiment and later we describe other possible solutions. Please refer to the figure below (FIG. 11a).

At the handover trigger point the UE sends a measurement report to the target eNB. The fields included in this measurement report may be configured by the source eNB. As a minimum we could for instance require the source cell and target cell qualities (RSRP or RSRQ). The source eNB can also configure different triggered measurements for handover purposes, such as Event A3. The choice is not critical to the invention, any recognized method can be used, the important aspect is the measurement report.

At the handover trigger point the source eNB may measure the uplink link quality of the UE by, for example, examining the UE Power Headroom associated with the transmitted measurement report.

To capture the uplink radio conditions at the end of handover execution the target cell needs to perform measurements on the uplink transmissions in steps 9 and 11 in FIG. 11a. For example, the RRCConnectionReconfigurationComplete message (message 11) can indicate the UE power headroom to the target eNB—this expresses how close the UE is to transmitting at maximum power. This can be used to determine what the margin (dB) is for UE to make a successful transmission on the uplink. Clearly a successful transmission in steps 9 and 11 is necessary for a successful handover—if the margin before the UE hits maximum power is small then this could suggest to the optimization algorithm that some future handovers may fail (too early) unless the handover parameters are adjusted.

In step 9 the UE makes a PRACH transmission to the target eNB. The transmission power is set by an open-loop method—the UE estimates the path loss to the eNB and transmits at a power level to achieve a certain receive power value at the eNB. If a RACH attempt fails the power may be ramped up by the UE (to improve audibility). The eNB can measure the received power on the PRACH, and a value smaller than expected may indicate that the path loss estimate made by the UE was optimistic or the UE may have been restricted to its maximum power level. Furthermore, the eNB may configure contention based RACH access for step 9. With contention-based access the UE chooses a preamble sequence from either set A or set B according to the path loss estimate by the UE (relative to a threshold). In these circumstances the eNB can determine the path loss of the UE relative to the threshold, this can also indicate some aspect on the link quality.

Thus, there are several possible measures, for instance for downlink quality: downlink path loss, signal strength, signal quality, mobile terminal power headroom could be used as a measure. In a 3GPP system, specific examples of possible measures for downlink quality are: RSRP, RSRQ. Also UE Power Headroom may be used. Thus, for the previous step of the method according to the invention said any measure of a link quality may be any of path loss, signal strength, for a 3GPP Long Term Evolution-system: RSRP, RSRQ, UE Power Headroom.

In summary, the solution captures for every successful handover between two cells the following information for the handover parameter optimization function:

At the end of handover execution
Uplink link quality from UE to target cell
Downlink link quality from target cell to UE
Downlink link quality from source cell to UE

At the handover trigger
Uplink link quality from UE to target cell
Downlink link quality from target cell to UE
Downlink link quality from source cell to UE

After the handover execution
Uplink link quality from UE to target cell
Downlink link quality from target cell to UE
Downlink link quality from source cell to UE

For some aspects of the embodiment the measurements performed at the trigger point and at the end of handover execution needs to be collated at one eNB. Generally, handover optimization is best performed at the source eNB rather than the target eNB because the source has rich contextual information on the UE behaviour before the handover. For example, it knows whether the UE was in DRX state. If the optimization is performed outside of the E-UTRAN, for example, in the OAM system, it still makes sense to collate statistics at the source eNB and capture measurements on outgoing handovers. Thus, measurements at the end of the handover execution should be passed from the target eNB to the source eNB. One way of doing this would be to extend the existing UE Context Release message to carry the measurements. Alternatively a new message could be devised exclusively for this purpose.

All measurements may be collated at the target eNB rather than the source eNB as described above. A convenient way to do this would be to extend the existing Handover Request message (step 4 in FIG. 11a) to carry the source and target RSRP/RSRQ measurements (passed in the UE measurement report, step 2). The measurements may also be useful to the target in its admission control process (step 5).

Thus, when a plurality of measures of a link quality are collected in any of the steps of the method according to the invention, the method may further comprise a step to

gather said plurality of measures at one entity in the mobile telecommunications system.

There are different options as to the entity where said plurality of measures are gathered. It could be any of: the mobile terminal, the first basestation, the second basestation, and a management entity.

Further, when any measure of a link quality is measured in the mobile terminal in any of the steps of the method according to the invention, the method may further comprise a step to

forward said any measure of a link quality from the mobile terminal to the second basestation.

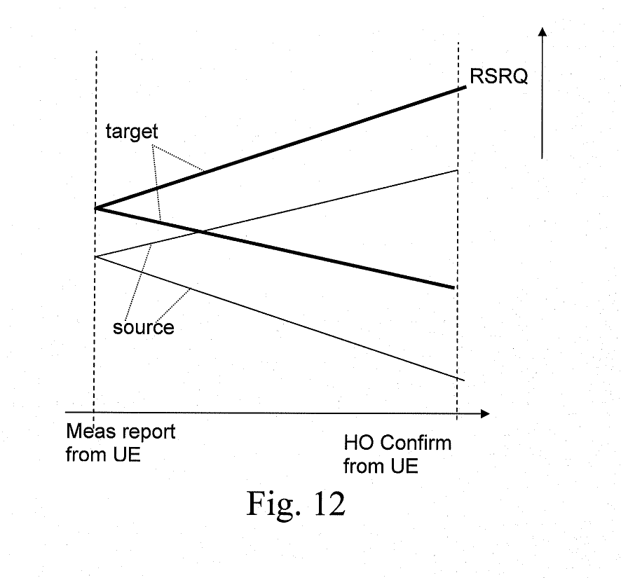

Also, alternatively, the UE could simply indicate the trend in the RSRQ (or RSRP) variation with time. This is illustrated in FIG. 12. Note, with a positive handover offset we expect the target quality to be better than the serving cell at the trigger point (measurement report), as drawn. For a normal handover we expect the source RSRQ to fall with time and the target RSRQ to increase. In the needle effect both source and target qualities fall with time. To signal the trend requires only 2 bits—this would replace the UE measurements in the handover confirmation. Therefore, in conjunction to the previous step of the method according to the invention, it is possible to forward as said any measure of a link quality: a link quality trend indication between the time of handover trigger to the time of handover execution completion from the mobile terminal to the second basestation.

In order to capture the downlink radio conditions at the end of handover execution point UE measurements need to be taken and passed to the target cell. One possibility would be to include them in the RRCConnectionReconfigurationComplete message. This would require a change to the existing 3GPP specifications. A 3GPP compliant method would be for the target cell to configure the UE via the RRCConnectionReconfiguration in step 7 to send an immediate snap-shot measurement of its downlink reference symbol, and also the downlink of the source cell after reception of the handover confirm. In the figure, we suggest that measurements are carried in a separate measurement report. This could be configured by a new measurement configuration by the target eNB—this may be explicitly setup using downlink RRC signaling immediately after the handover execution has ended (message not shown in figure) or it could be configured in some way in the HO Command (step 7) along with other settings to be used in the target cell. Measurements (RSRP or RSRQ or path loss) are only required of the source and target cell (no other neighbours). Additional measurements may be performed after the handover execution as suggested above. For example, the UE could be configured (in step 7) to report periodically every 200 ms for a duration of 5 seconds, the first report occurring shortly after the handover execution has ended. This is possible with existing 3GPP signaling. Multiple measurement reports after the handover completion are illustrated in FIG. 11b.

Measurements taken at the end of handover execution and passed in the RRCConnectionReconfigurationComplete to the target eNB was discussed above.

Measurements made by the UE at the time of the trigger may be passed to the target cell by the UE in the handover confirmation (RRCConnectionReconfigurationComplete). This could be useful if the measurement analysis is performed at the target cell, and avoids the need to signal this information between eNBs. These are examples of measures that could be encapsulated in the RRCConnectionReconfigurationComplete message, when operating in a 3GPP LTE environment. Therefore, in conjunction with any of the two previous steps, the method according to the invention, could be adapted for a 3GPP Long Term Evolution system, to forward said any measure of a link quality from the mobile terminal to the second basestation using the message RRCConnectionReconfigurationComplete.

A more advanced concept would be to configure the UE to take multiple measurements during the handover preparation and execution. It could be limited to the execution part only and configured in the HO command to the UE, or configured before the handover and initiated on the transmission of the triggered measurement. When the UE has successfully handed over to the target, these measurements could be “played back” to the target eNB—this is a form of measurement tape recorder.

In order to configure the mobile terminal to send measure of link quality, the method according to the invention can further comprise, when in a 3GPP Long Term

### Evolution System:

let second basestation configure the mobile terminal, via message

RRCConnectionReconfiguration sent from the first basestation, to send the measure of a link quality from the mobile terminal to the second basestation.

When in a 3GPP Long Term Evolution system, signalling from the second basestation to the first basestation can be performed in the method of the invention, in conjunction with any suitable step of said method:

signal any measure of a link quality from the second basestation to the first basestation via any of the following messages: UE Context Release message; other message.

Following measurement capture and measurement distribution to one point, the source eNB, analysis of the handover may be performed and corrective actions identified. In the following we assume that analysis is performed at the eNB and corrective actions are also performed by the eNB. However, this does not preclude the location of the analysis or action identification elsewhere, e.g. in an OAM system. Indeed the function could be split into two parts, for example, analysis could be done by the eNB (this is basically statistics gathering) and the optimization function that decides upon actions to take could be located in the OAM system.

Therefore, evaluation of any measure can take place in a suitable entity of the mobile telecommunications system, such as in the first basestation, second basestation or in an Operations and Maintenance system. This is in dependence on what is appropriate for the actual implementation. Therefore, the method according to the invention, can comprise: the step of evaluation of any measure of a link quality in regard of handover problem identification,

evaluate said any measure in any of: the first basestation, the second basestation and a management entity.

After capturing measurements from a statistically significant number of handovers, the following problems may be recognized:
Too early handover (leading to handover failure)
Uplink link quality from UE to target cell or the downlink link quality from target cell to UE at the end of handover execution are poor (lying below specified respective thresholds).
Why ? Too early handover failures occur when either the downlink or the uplink between target cell and UE prevent the transfer of the handover confirmation message from the UE.
   Too early handover (leading to ping-pong)
The difference between source cell downlink quality and target cell downlink quality is small at the end of the handover execution.
Why? If the difference is small then this increases the likelihood that the UE may soon handover back to the source cell.
The difference between target cell downlink quality and source cell downlink quality reduces after the handover execution.
Why? Same reason.

Too early handover (leading to unnecessary handover to intermediate cell, the needle case).
Both the source and target downlink link qualities deteriorate with time (between the two sets of measurements)
Why? The target cell may have looked attractive at (and before) the trigger point but a little later, at the end of the handover execution, the source and the target are both weakening suggesting that the coverage of the target cell was limited (a needle) and it would be better to handover to a third cell.
Both the source and target downlink link qualities deteriorate with time after the HO execution
Why? The target cell may have looked attractive at (and before) the trigger point but a little later, after the end of the handover execution, the source and the target are both weakening suggesting that the coverage of the target cell was limited (a needle) and it would be better to handover to a third cell.

### Handover Parameter Adjustment

Depending on the outcome of an evaluation of any measure of a link quality in regard of handover problem identification, steps may be taken to adjust handover settings in the telecommunications system. Handover parameters may be adjusted in a distributed fashion by the eNB directly, or by the OAM

system (Configuration Management of the eNB, a centralized method). In the distributed method negotiation between eNBs may be required. Accordingly, the method according to the invention may comprise a step, wherein after the step of evaluation of any measure of a link quality in regard of handover problem identification,

adjust at least one handover setting in the telecommunications system.

A typical solution to a too early handover is to increase the handover offset (assuming the handover trigger is when the target cell is offset better than serving cell). Another possible solution would be to extend the TimeToTrigger parameter. Other solutions are not precluded here.

Therefore, such an adjustment may for the case of 3GPP LTE system for instance comprise changing a handover offset or a TimeToTrigger parameter. The method according to the invention would in that case include a step: wherein when in a 3GPP Long Term Evolution system, adjust at least one handover setting by:

changing any of: a handover offset; a TimeToTrigger parameter.

The method of the invention has been described in the context of a general mobile telecommunications system that employs handover for mobile terminals travelling the system. As a specific implementation 3GPP LTE has been mentioned. However, the method is also applicable to other systems, such as UMTS. Therefore, the method according to the invention may further include a specification of the system in which a handover is made, namely the handover from the first station to the second station is a hard handover in a UMTS system.

Any step of the method of the invention may be implemented in a mobile terminal, where applicable. Therefore, the invention also comprises a mobile terminal for a mobile telecommunications system, the system including at least the mobile terminal, a first radio basestation and a second radio basestation, wherein the mobile terminal is adapted to be able to communicate with said basestations and to do a handover from the first basestation to the second basestation. The mobile terminal is distinguished in that it is adapted to take at least one measure of a link quality between the mobile terminal and any of the basestations at an end of a successful handover execution of the mobile terminal from the first basestation to the second basestation, the mobile terminal further being adapted to transfer the at least one measure of a link quality to any entity of the telecommunications system able to evaluate any measure of a link quality in regard of handover problem identification. This would be a basic embodiment of the mobile terminal according to the invention corresponding to a basic embodiment of the method according to the invention. For each applicable additional step of the method of the invention, the mobile terminal may be amended to include features that are adapted to perform such a step in the mobile terminal.

Any step of the method of the invention may be implemented in a radio basestation, where applicable. Therefore, the invention also comprises a radio basestation for a mobile telecommunications system, the system including at least the radio basestation, a second radio basestation, and a mobile terminal able to communicate with said basestations and to do a handover from one of them to the other. The basestation is distinguished in that it is adapted to take at least one measure of a link quality between the mobile terminal and the basestation at an end of a successful handover execution of the mobile terminal from one of the basestations to the other, the basestation further being adapted to transfer any measure of a link quality to any entity of the telecommunications system able to evaluate the at least one measure in regard of handover problem identification. This would be a basic embodiment of the radio basestation according to the invention corresponding to a basic embodiment of the method according to the invention. For each applicable additional step of the method of the invention, the radio basestation may be amended to include features that are adapted to perform such a step in the basestation.

Any step of the method of the invention may be implemented in a management entity, where applicable. Therefore, the invention also comprises a management entity for a mobile telecommunications system, the system including at least a first radio basestation, a second radio basestation and a mobile terminal able to communicate with said basestations and to do a handover from one of them to the other. The management entity is distinguished in that it is adapted to receive at least one measure of a link quality between the mobile terminal and any of the stations, the at least one measure taken at an end of a successful handover execution of the mobile terminal from the first basestation to the second basestation, and to evaluate any measure of a link quality in regard of handover problem identification or it is adapted to receive an evaluation, in regard of handover problem identification, of at least one measure of a link quality between the mobile terminal and any of the stations, the at least one measure of a link quality taken at an end of a successful handover execution of the mobile terminal from the first basestation to the second basestation. This would be a basic embodiment of the management entity according to the invention corresponding to a basic embodiment of the method according to the invention. For each applicable additional step of the method of the invention, the management entity may be amended to include features that are adapted to perform such a step in the basestation.

1. Method for handover problem identification in a mobile telecommunications system, the system including at least a first radio basestation, a second radio basestation and a mobile terminal able to communicate with said basestations, wherein said mobile terminal is adapted to do a handover from the first basestation to the second basestation, the method including:
taking at least one measure of a link quality between the terminal and any of the stations,
evaluating any measure of a link quality in regard of handover problem identification,
characterised by:
in the step of taking the at least one measure of a link quality, taking said at least one measure of a link quality at an end of a successful handover execution of the mobile terminal from the first basestation to the second basestation.

2. Method according to claim 1, further comprising:
additionally taking at least one second measure on link quality between the terminal and any of the basestations at a time of a handover trigger of the mobile terminal.

3. Method according to claim 1, further comprising:
additionally taking at least one third measure on link quality between the terminal and any of the basestations in a time interval between a time of a handover trigger and a time of a handover execution completion of the mobile terminal.

4. Method according to claim 1, further comprising:
additionally taking at least one fourth measure on link quality between the mobile terminal and any of the basestations in a time interval following handover completion of the mobile terminal.

5. Method according to claim 4, further comprising:
in the time interval following handover completion:
taking multiple measures on link quality between the terminal and any of the basestations periodically in the time interval.

6. Method according to claim 1, further comprising:
for any measure of a link quality between the terminal and any of the basestations,
taking as said any measure of a link quality any of: uplink link quality from mobile terminal to second basestation, uplink link quality from mobile terminal to first basestation, downlink link quality from second basestation to mobile terminal, and downlink link quality from first basestation to mobile terminal.

7. Method according to claim 6, wherein said any measure of a link quality is any of path loss, signal strength, signal quality, UE power headroom, for a 3GPP Long Term Evolution-system: RSRP, RSRQ, UE Power Headroom.

8. Method according to claim 1, wherein when a plurality of measures of a link quality are collected,
gathering said plurality of measures at one entity in the mobile telecommunications system.

9. Method according to claim 8, wherein the entity where said plurality of measures are gathered is any of: the mobile terminal, the first basestation, the second basestation, and a management entity.

10. Method according to claim 1, wherein when any measure of a link quality is measured in the mobile terminal,
forwarding said any measure of a link quality from the mobile terminal to the second basestation.

11. Method according to claim 10, forwarding as said any measure of a link quality comprises: a link quality trend indication between the time of handover trigger to the time of handover execution completion from the mobile terminal to the second basestation.

12. Method according to claim 10, for a 3GPP Long Term Evolution system, comprising forwarding said any measure of a link quality from the mobile terminal to the second basestation using the message RRCConnectionReconfigurationComplete.

13. Method according to claim 1, wherein when in a 3GPP Long Term Evolution system:
allowing second basestation configure the mobile terminal, via message RRCConnectionReconfiguration sent from the first basestation, to send the measure of a link quality from the mobile terminal to the second basestation.

14. Method according to claim 1, wherein when in a 3GPP Long Term Evolution system comprising:
signaling any measure of a link quality from the second basestation to the first basestation via any of the following messages: UE Context Release message; other message.

15. Method according to claim 1, wherein the step of evaluating of any measure of a link quality in regard of handover problem identification comprises,
evaluating said any measure in any of: the first basestation, the second basestation and a management entity.

16. Method according to claim 1, wherein after the step of evaluating of any measure of a link quality in regard of handover problem identification the method comprises,
adjusting at least one handover setting in the telecommunications system.

17. Method according to claim 1, wherein the handover from the first station to the second station is a hard handover in a UMTS system.

18. A mobile terminal for a mobile telecommunications system, the system including at least the mobile terminal, a first radio basestation and a second radio basestation, wherein the mobile terminal is configured to communicate with said basestations and to perform a handover from the first basestation to the second basestation, wherein the mobile terminal is configured to take at least one measure of a link quality between the mobile terminal and any of the basestations at an end of a successful handover execution of the mobile terminal from the first basestation to the second basestation, the mobile terminal further being adapted to transfer the at least one measure of a link quality to any entity of the telecommunications system able to evaluate any measure of a link quality in regard of handover problem identification.
